(19) United States
(12) Patent Application Publication
(10) Pub. No.: US 2012/0327593 A1
(43) Pub. Date: Dec. 27, 2012

(54) Tablet computer holding device

(76) Inventors: Sean W. Finnegan, Stillwater, MN (US); Dennis R. Milliman, Coon Rapids, MN (US)

(21) Appl. No.: 13/422,809

(22) Filed: Mar. 16, 2012

Related U.S. Application Data
(60) Provisional application No. 61/501,511, filed on Jun. 27, 2011.

(51) Int. Cl. G06F 1/16

(52) U.S. Cl. 361/679.56

(57) ABSTRACT

A tablet computer holding device comprising a pair of grip portions engaging the tablet computer and a bridge portion connected to and in communication with the grip portions. The ergonomically shaped grip portions include an engagement notch, thumb groove, and plurality of finger grooves to provide a comfortable handle for holding a tablet computer. The bridge portion includes an anti skid surface and is elastic and extensible to allow the device to be attached to various sizes of tablet computers and to be used with either the portrait or landscape orientation of the tablet computer.

### CROSS REFERENCE TO RELATED APPLICATIONS

This application claims the benefit of provisional application Ser. No. 61/501,511, filed 2011 Jun. 27 by the present inventors.

### FEDERALLY SPONSORED RESEARCH

Not Applicable

### SEQUENCE LISTING OR PROGRAM

Not Applicable

### FIELD OF THE INVENTION

The present invention relates to a device used to hold a tablet computer, tablet-style computer, or slate computer.

### BACKGROUND OF THE INVENTION

The “tablet” or “slate” computer has quickly risen in popularity, mainly due to the introduction of the iPad®. These “tablets,” as they are often called, come in varying sizes but all share common features in that they have a thin profile, a lightweight design, and a touch screen. It is these properties that, although beneficial for the user, can cause the user discomfort during prolonged usage. The user operating one of these tablet devices, is required to hold the device at its edges, so as to not touch the sensitive touch screen, and often holds the product with one hand while using the other hand to operate the aforementioned touch screen. The thin profile of these tablet devices can make holding them uncomfortable over a long period of time as the slim profile does not conform to the size of the user's hand. Therefore, a device is needed to attach to the tablet to allow a user to easily and comfortably hold the tablet. Preferably, this device will cover a wide range of sizes and be operable when the tablet is used in both a landscape and portrait orientation.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is a perspective view of device, according to the present invention;

FIG. 2 is a top view of the device, according to the present invention;

FIG. 3 is a side view of the device, according to the present invention;

FIG. 4 is a perspective view of an additional embodiment of the device, according to the present invention;

FIG. 5 is a top view of an additional embodiment of the device, according to the present invention; and

FIG. 6 is a side view of an additional embodiment of the device, according to the present invention.

### DETAILED DESCRIPTION OF THE INVENTION

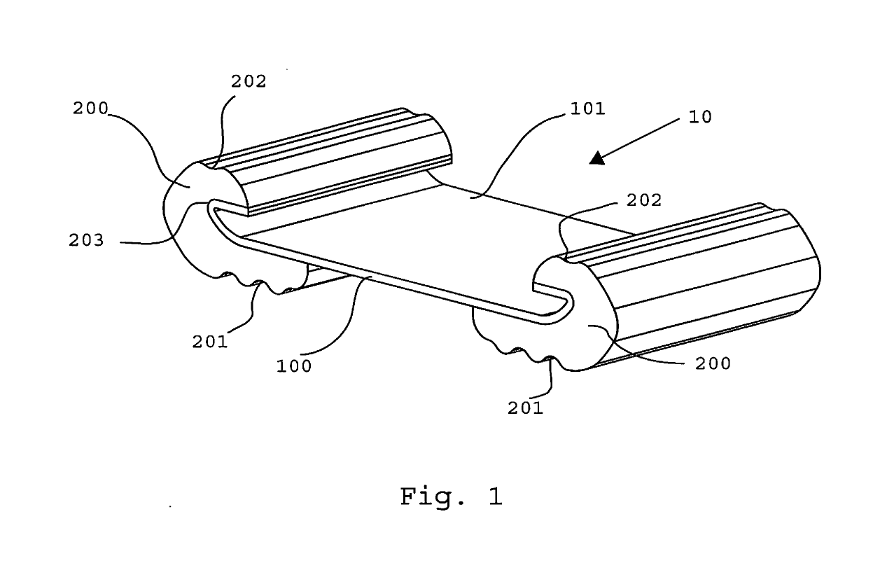

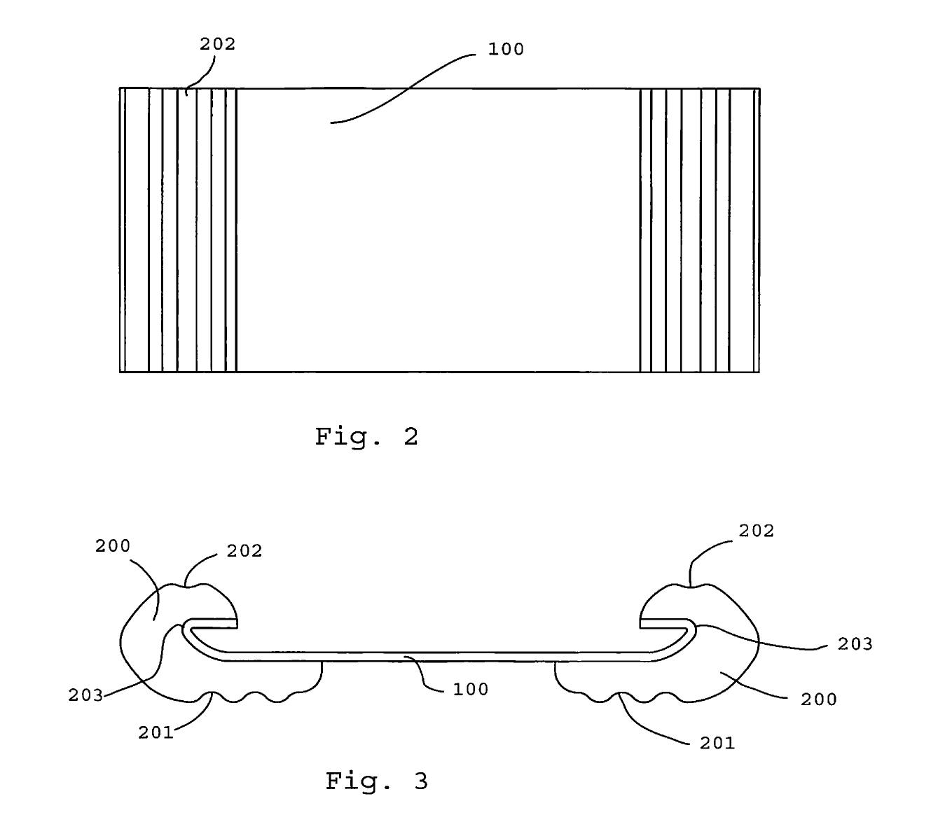

Referring now to FIGS. 1-3 there is shown an embodiment of the of a tablet computer holding device of the present invention, generally designated by the reference numeral 10. The tablet computer holding device 10 includes a pair of grip portions 200 and a bridge portion 100. The bridge portion 100 has an upper end anti skid portion 101. The grip portions 200 are identically shaped to be received comfortably in a users hand and are in communication through a connection with the bridge portion 100. The grip portions 200 may include a plurality of finger grooves 201, a thumb groove 202, and an engagement notch 203. The grip portions 200 are ergonomically crescent shaped with the engagement notch 203 interior to this shape. The engagement notch 203 is shaped to receive the edge of the tablet device. Often these tablet devices have a flat top edge and beveled or curved bottom edge, therefore the engagement notch 203 is shaped to conform to and receive these edges. The finger grooves 201 and thumb groove 202 are shaped to comfortably receive a users thumb and fingers, with the thumb groove 202 adjacent to the top of the tablet device and the finger grooves 201 adjacent to the bottom of the tablet device.

In the preferred embodiment of the present invention, the bridge portion 100 is elastic and extensible in a horizontal direction to allow the device to be used with several different sizes of tablets and in both the portrait and landscape formats. The elasticity of the bridge portion 100 provides a grasping force to the tablet and aides in the attachment of the grip portions 200 to the tablet edge. Preferably the bridge portion 100 is constructed out of neoprene or low resilience polyurethane (“LRPu”) for its extensibility, elasticity, and softness, although other similar materials with consistent properties may be used. It is desired that any material used be soft so as to not mar or scratch the tablet computer. Preferably, the grip portion 200 is constructed out of closed cell crosslinked polyethylene foam, although other materials with similar properties may be used. Closed cell crosslinked polyethylene foam is the ideal material as it is lightweight, provides comfort to the user of the device, and will not scratch or mar the tablet device.

In the preferred embodiment, the bridge portion 100 is fastened to the grip portion 200 using hot glue. Additionally, the grip portion 200 is designed with an extend lower half to allow for a plurality of finger grooves 201 and provide support over the length of the tablet computer device, wherein a user can comfortably and stably rest the tablet computer, with the tablet holding device engaged, on a flat surface.

In use, a user will engage one of the grip portions 200 with a first edge of the tablet computer. The user will then stretch and extend the bridge portion 100 to a desired length corresponding to the width of the tablet computer and engage the other grip portion 200 with the second edge of the tablet computer. The elastic compression of the bridge portion 100 will securely hold and engage grip portions 200 with the edges of the tablet computer. This engagement will be further enhanced by the anti skid surface 101 fastened to bridge portion 100. Due to the comfortable and ergonomic shape of the grip portions 200, a user will be able to comfortably hold the tablet computer with the user's thumbs and fingers comfortably resting in thumb groove 202 and finger grooves 201.

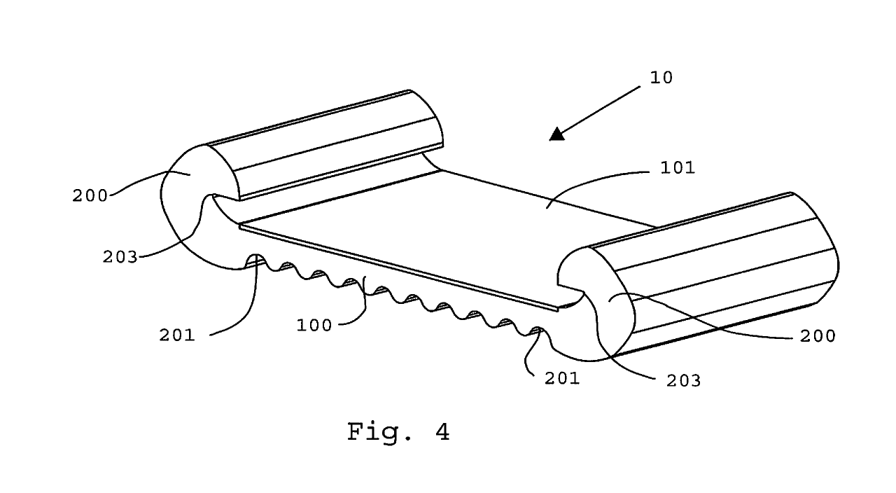

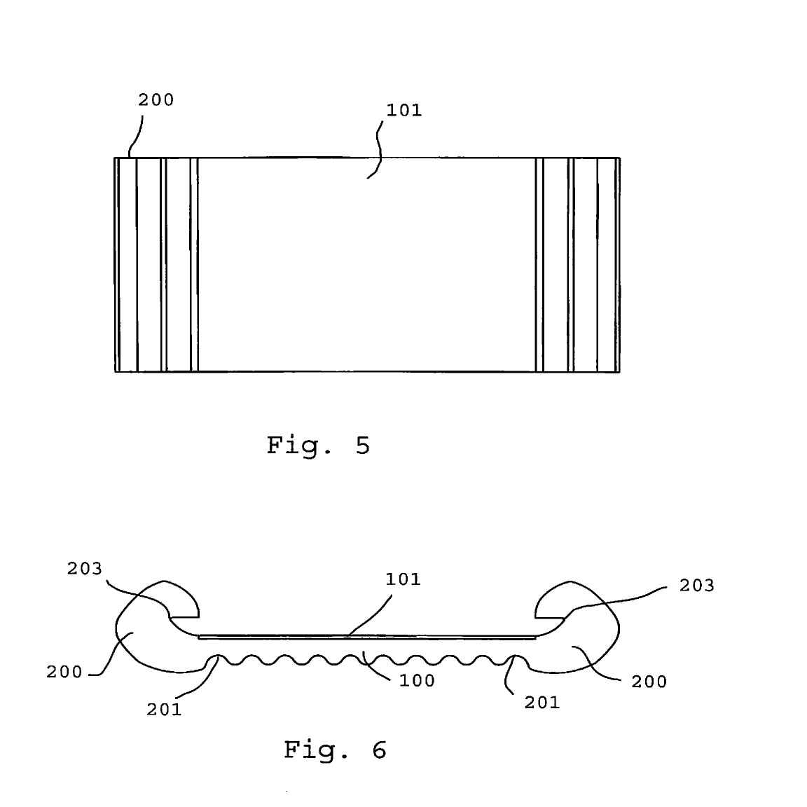

Referring now to FIGS. 4-6, an additional embodiment of the tablet computer holding device according to the present invention is generally designated by numeral 10. In this embodiment the tablet holding device is constructed in a one-piece fashion and contains a bridge portion 100 with anti skid surface 101 and a pair of grip portions 200 with an engagement notch 203 and a plurality of finger grooves 201. In this embodiment of the present invention, the tablet holding device 10 will need to be properly sized to fit a desired tablet computer and will not be able to attach to a standard tablet computer in both the portrait and landscape formats.

The bridge portion 100 and the grip portions 200 are constructed out of a single piece of material with the bridge portion 100 providing communication between two identically shaped grip portions 200. The material used must have some flexibility to allow the device to be tightly fit around the tablet computer. The grip portions 200 are ergonomically crescent shaped and include an engagement notch 203 and a plurality of finger grooves 201. The engagement notch 203 is shaped to receive the edge of a tablet computer. The plurality of the finger grooves 201 are shaped to comfortably receive the fingers of the user and allow the user to comfortably grasp the tablet holding device 10. In this embodiment, finger grooves 201 may extend the length of the bridge portion 100 to provide consistent ascetics and allow the user multiple options for finger placement and comfort.

Preferably, the tablet holding device 10 is constructed out of closed cell crosslinked polyethylene foam, although other materials with similar properties may be used. Closed cell crosslinked polyethylene foam is the ideal material as it is lightweight, provides comfort to the user of the device, and will not scratch or mar the tablet device, and is flexible with elastic properties allowing a one-piece structure to be stretched around the edges of a tablet computer in a secure fashion.

Usage of this embodiment is similar to the prior embodiments listed. A user will engage one of the grip portions 200 with a first edge of the tablet computer. The user will then engage the other grip portion 200 with the second edge of the tablet computer. The properly sized bridge portion 100 will securely hold and engage the grip portions 200 with the edges of the tablet computer. This engagement will be further enhanced by the anti skid surface 101 fastened to the bridge portion 100. A user will then be able to comfortably hold the tablet computer due to the comfortable and ergonomic shape of the grip portions 200.

1. A tablet style computer holding device comprising:
a pair of grips, the grips in communication with the tablet edge; and
a bridge portion of extensible material connected to the grips.

2. The tablet style computer holding device as claimed in claim 1, wherein the grips have a notch in communication with the tablet edge.

3. The tablet style computer holding device as claimed in claim 1, wherein the top bridge portion has an anti-skid surface in communication with the tablet.

4. The tablet style computer holding device as claimed in claim 1, wherein the grips are a crescent shape with a notch interior to the crescent shape.

5. The tablet style computer holding device as claimed in claim 1, wherein the grips have a plurality of grooves.

6. The tablet style computer holding device as claimed in claim 1, wherein the grips are constructed of closed cell crosslinked polyethylene foam.

7. The tablet style computer holding device as claimed in claim 1, wherein the bridge portion is constructed out of low resilience polyurethane.

8. A tablet computer holding device comprising:
a pair of grips, the grips having a notch in communication with the tablet edge and having a plurality of grooves; and
a bridge portion of extensible material connected to the grips, the top bridge portion having an anti-skid surface in communication with the tablet.

9. A tablet computer holding device as claimed in claim 8, wherein the grips are a crescent shape with the notch interior to the crescent shape.

10. A tablet computer holding device as claimed in claim 8, wherein the grips are constructed out of closed cell cross linked polyethylene foam.

11. A tablet computer holding device as claimed in claim 8, wherein the bridge portion is constructed out of low resilience polyurethane.

12. A tablet computer holding device comprising:
a pair of grips, the grips having a notch in communication with the tablet edge and having a plurality of grooves; and
a bridge portion connected to the grips, the top bridge portion having an anti-skid surface in communication with the tablet.

13. A tablet computer holding device as claimed in claim 12, wherein the device is constructed out of closed cell cross linked polyethylene foam.
